(19) United States
(12) Patent Application Publication
(10) Pub. No.: US 2006/0166656 A1
(43) Pub. Date: Jul. 27, 2006

(54) Cell or mobile phone, and wireless PDA traffic advisory method

(76) Inventors: Michael Klicpera, La Jolla, CA (US); Ross Tsukashima, San Diego, CA (US)

Correspondence Address: MICHAEL E. KLICPERA, PO BOX 573, LA JOLLA, CA, 92038-0573, US

(21) Appl. No.: 11/338,198

(22) Filed: Jan. 24, 2006

Related U.S. Application Data
(60) Provisional application No. 60/646,395, filed on Jan. 24, 2005.

(51) Int. Cl. H04Q 7/22

(52) U.S. Cl. 455/414.3; 455/3.06

(57) ABSTRACT

Disclosed herein is a method which allows the cell phone operator to download traffic information on the operators cell phone display with a minimum of keystrokes. The cell phone can have a option mode, voice activation or a sequence of keystrokes programmed within the cell or mobile phone to facilitate access of the cell or mobile phone to regional traffic information. This is accomplished by the cell or mobile phone service provider procuring traffic information and data from traffic information provided by an entity such as Traffic Pulse. Alternately the cell phone service provider can make internet access to a traffic information provider directly to the operator of the cell phone. Besides having to first access the internet from a cell phone, and then second navigate to a traffic information website, an operator must provide location information, such as current position through zip code, address, or longitudinal and latitudinal coordination. Cell and mobile phone technology already has the function to monitor the locations of a cell or mobile phone to access various cell phone transmitting and receiving towers in close proximity to the cell or mobile phone. This is accomplished by one example known as triangulation measurement or hyperbolic multi-lateration positioning of cell signals between cell towers or through GPS technology incorporated in the cell or mobile phone. Therefore, the use of current location information of a cell phone acquiring regional traffic data does not need to this information be input, using keystrokes on the cell phone keyboard, or by voice annunciations by the cell phone operator.

### CROSS-REFERENCE TO RELATED APPLICATIONS

This application claims priority from U.S. Provisional Application No. 60/646,395 filed on Jan. 24, 2005, which is hereby incorporated by reference in it entirety. Disclosure Document No. 564534, deposited with the U.S. Patent and Trademark Office on Oct. 29, 2004, is also incorporated by reference in its entirety.

### FIELD OF THE INVENTION

The field of art to which this invention relates is cell, mobile or portable phones, and computer and internet technology. More specifically, the present invention relates to a method for displaying regional traffic information on a user's cell phone.

### BACKGROUND OF THE INVENTION

Cell, mobile, portable phones and wireless PDAs (personal digital assistants) must communicate with wireless transmitting and receiving towers that are installed, operated and maintained by various cell, mobile and portable phone service or provider companies. Some of the current and larger service or provider companies are Sprint Corporation, Verizon Communication Inc., AT&T Wireless, T-Mobile and Cingular and will be referred to as cell or mobile phone companies in this application. It also should be noted that the Applicant asserts that the terms ‘cell phone’, ‘mobile phone’ and ‘portable phone’ are interchangeable through this application. Some of the current and larger cell or mobile phone manufacturers or distributors are Qualcomm, LG Industries, Nokio, Sony, Samsung, Ericsson, Kyocera, and Motorola.

The cell or mobile phone technology generally allows an individual to become wirelessly connected to the internet for viewing various internet websites. Viewing traffic information on internet websites can be obtained from various private and government entities. For example, many state transportation department (e.g. the California transportation department (CalTrans) or state highway patrol department (e.g. the California Highway Patrol department (CA CHP) publishes publicly accessible traffic information over the internet. For an example of a private entity providing traffic information over the internet is Traffic Pulse (available over the internet at www.traffic.com) which is commercially available over the internet. The internet website Traffic Pulse is marketed and managed by Mobility Technologies® with corporate offices located in Wayne, Pa. Mobility Technologies is one of the providers of real-time traffic and logistic solutions for consumers, businesses, and transportation agencies. They combine state of the art traffic data collections techniques and information technology through innovative traveler information systems providing accurate and reliable. One problem with cell phone utilization in acquiring traffic information over the internet is that to view regional traffic information the acquisition of the internet and navigation through the internet and gathering regional specific information is input and keystroke cumbersome. This is potentially prohibitive when one is driving and navigating a vehicle on freeways, and toll roads, especially when encountering busy and crowded traffic conditions.

### SUMMARY OF THE INVENTION

Disclosed herein is a method which allows the cell phone operator to download traffic information on the operators cell phone display with a minimum of keystrokes. The cell phone can have an option mode, voice activation or a sequence of keystrokes programmed within the cell or mobile phone to facilitate access of the cell or mobile phone to regional traffic information. This is accomplished by the cell or mobile phone service provider procuring traffic information and data from traffic information provided by an entity such as Traffic Pulse. Alternately the cell phone service provider can make internet access to a traffic information provider directly to the operator of the cell phone. Besides having to first access the internet from a cell phone, and then second navigate to a traffic information website, an operator must provide location information, such as current position through zip code, address, or longitudinal and latitudinal coordination. Cell and mobile phone technology already has the function to monitor the locations of a cell or mobile phone to access various cell phone transmitting and receiving towers in close proximity to the cell or mobile phone. This is accomplished by one example known as triangulation measurement or hyperbolic multi-lateration positioning of cell signals between cell towers or through GPS technology incorporated in the cell or mobile phone. Therefore, the use of current location information of a cell phone acquiring regional traffic data does not need to this information be input, using keystrokes on the cell phone keyboard, or by voice annunciations by the cell phone operator.

It is a function of the present invention method to facilitate the transfer and downloading of regional traffic to an operator's cell or mobile phone video display.

It is a function of the present invention method to facilitate the transfer and downloading of regional traffic to an operator's cell or mobile phone video display with a minimum of user input by keystrokes or voice annunciations.

It is also a function of the present invention method to facilitate the transfer and downloading of regional traffic to an operator's cell or mobile phone video display which minimizes compromising the vehicle operator's attention while driving a motorize vehicle.

### BRIEF DESCRIPTION OF THE DRAWINGS

The invention can be better understood by reference to the following description, taken in connection with the accompanying drawings.

FIG. 1 is a perspective view of the cell or mobile phone service or company having a traffic information storage or quick access facility, the owner's holding his/her cell or mobile phone in a moving vehicle, and the owner's cell or mobile phone showing regional traffic information on the display.

FIG. 2 is a block diagram describing the typical cell or mobile phone traffic information accessing states used in cell phone communications and the methods of the present method invention.

### DESCRIPTION OF THE PREFERRED EMBODIMENT

Before the present method of transferring traffic information to a cell phone, mobile phone, or wireless PDA (PDA with wireless capability), it is to be understood that this application is using the either the term cell, mobile or wireless PDA to represent the category of devices that subscribe to wireless services and can provide graphic information on a display. It also should be understood that cell or mobile phone manufacturers incorporate various forms of software technology that is based upon various operating systems. The present invention method is not limited to either any particular cell phone service/provider or any cell or mobile phone manufacturer.

It must be noted that as used in this specification and the claims, the singular forms “a”, “and” and “the” include the plural reference unless the contexts clearly dictates otherwise. The publications and web sites discussed herein are provided solely for their disclosure prior to the filing date of the present application. Nothing herein is to be construed as an admission that the present invention is not entitled to antedate such publication by virtue of prior invention.

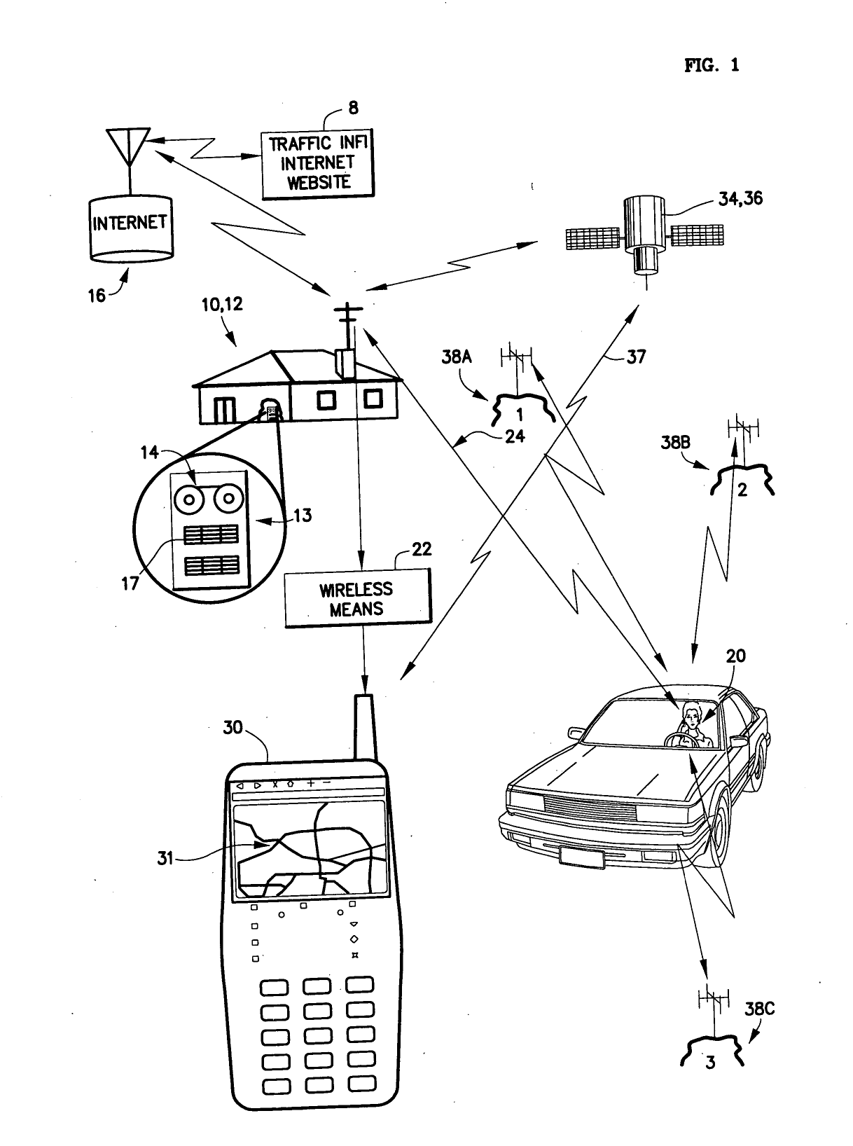

FIG. 1 is a perspective view of the cell or mobile phone service or company 10 having a traffic information storage facility 12 or quick internet access facility, the owner's 20 holding his/her cell/mobile phone or wireless PDA 30 in a moving vehicle, and the owner's 20 cell/mobile phone or wireless PDA 30 showing regional traffic information 50 on the display 33. The communication means 24 and facility 10, 12 depicted on FIG. 1 are meant to represent the typical cell or mobile phone company structure. Generally the cell or mobile company has a facility which may have a computer 13, with hard drive system 17 or tape system 14 for processing and providing back-up of data. As represented in FIGS. 1 (and 2), the cell phone operators must first initiate the request for regional traffic information. This can be accomplished by pressing a dedicated key on said cell phone or wireless PDA or pressing a series of keys on the cell phone wireless PDA 42 or making voice activation means 44 (which has previously been programmed into the cell phone). The dedicated key, series of keys, 42 or voice activation means 44 can initiate a software macro sequence that logins in to a internet provider 16, then accesses a specific website 8 which has regional traffic information 50, and then downloads regional traffic information 60 on the display 33 of the cell phone or wireless PDA 30.

The cell or mobile phone, or wireless PDA 30 are semi-continuously communicating with remotely located base cell tower stations 38a, 38b, 38c that are operated and maintained by the cell or mobile phone company 10. Each base station consists of a tower and a small building or structure that contains radio transmitter and receiving equipment. The base station towers are generally steel pole or lattice structures that typically rise hundreds of feet above the ground and are positioned at strategic locations within a coverage area. The series of cell phone towers 38a, 38b, 38c can function to use hyperbolic multi-lateration positioning or triangulation technology means 48 to locate the position of a cell phone. The triangulation means 48 generally requires at least three cell phone towers to be in wireless communication with the cell phone. By analyzing how long it takes radio waves to travel from each of the cell towers from the cell phone or wireless PDA 30, an integrated computer can calculate the relative position of the cell phone or wireless PDA 30 within a regional area. Each cell or mobile phone company runs one or more central offices called the Mobile Telephone Switching Office (MTSO) in a region that communicates with the base stations. The MTSO handles all of the phone connections to the normal land-based phone system, and control all the base stations in the region and can conduct the regional location calculations.

In another embodiment, the location of the cell phone or wireless PDA is determined by utilizing the publicly accessed and available GPS (Global Positioning System). Many cell/mobile phone or wireless PDAs have or are governmentally mandated to incorporate GPS technology 46 into the device. One advantage of the incorporated GPS technology 46 is that when a cell/mobile phone or wireless PDA 30 calls 911, the 911 operator can determine the relative location of the cell/mobile or wireless PDA that made the call. GPS is funded by the public and controlled by the U.S. Department of Defense (DOD). While there are many thousands of civil users of GPS world-wide, the system was designed for and is operated by the U.S. military. In operation, GPS provides specially coded satellite signals 37 that can be processed in a GPS receiver (incorporated within the hardware and software of the present invention cell/mobile phone or wireless PDA) enabling the receiver to compute position, velocity and time. A plurality of (generally three or four) GPS satellite signals 37 communicate with the cell/mobile phone or wireless PDA 30 and are used to compute positions in two or three dimensions (depending on the number of satellites signals 37 received) and the time offset in the receiver clock. The nominal GPS Operational Constellation consists of 24 satellites 34 that orbit the earth in 12 hours. There are often more than 24 operational satellites 34 as new ones are launched to replace older satellites. The satellite orbits repeat almost the same ground track (as the earth turns beneath them) once each day. The orbit altitude is such that the satellites repeat the same track and configuration over any point approximately each 24 hours (4 minutes earlier each day). There are six orbital planes (with nominally four SVs in each), equally spaced (60 degrees apart), and inclined at about fifty-five degrees with respect to the equatorial plane. This constellation provides the user with between five and eight SVs visible from any point on the earth. It is anticipated by the Applicant that a private GPS or other similar wireless technology 36 might also be utilized with the present invention. The advantage of GPS is that the technology enables a receiver or microchip to compute the position, velocity and time of a cell phone. Further, when four GPS satellites are monitored, the technology enables the computation of positions in three dimensions (relative location and height.

In basic theory, the GPS operates in the following manner. The Master Control facility is located at Schriever Air Force Base (formerly Falcon AFB) in Colorado. These monitor stations measure signals from the SVs which are incorporated into orbital models for each satellites. The models compute precise orbital data (ephemeris) and SV clock corrections for each satellite. The Master Control station uploads ephemeris and clock data to the SVs. The SVs then send subsets of the orbital ephemeris data to GPS receivers over radio signals.

The SVs transmit two microwave carrier signals. The L1 frequency (1575.42 MHz) carries the navigation message and the SPS code signals. The L2 frequency (1227.60 MHz) is used to measure the ionospheric delay by PPS equipped receivers.

Three binary codes shift the L1 and/or L2 carrier phase. The C/A Code (Coarse Acquisition) modulates the L1 carrier phase. The C/A code is a repeating 1 MHz Pseudo Random Noise (PRN) Code. This noise-like code modulates the L1 carrier signal, “spreading” the spectrum over a 1 MHz bandwidth. The C/A code repeats every 1023 bits (one millisecond). There is a different C/A code PRN for each SV. GPS satellites are often identified by their PRN number, the unique identifier for each pseudo-random-noise code. The C/A code that modulates the L1 carrier is the basis for the civil SPS. The P-Code (Precise) modulates both the L1 and L2 carrier phases. The P-Code is a very long (seven days) 10 MHz PRN code. In the Anti-Spoofing (AS) mode of operation, the P-Code is encrypted into the Y-Code. The encrypted Y-Code requires a classified AS Module for each receiver channel and is for use only by authorized users with cryptographic keys. The P (Y)-Code is the basis for the PPS.

The Navigation Message also modulates the L1-C/A code signal. The Navigation Message is a 50 Hz signal consisting of data bits that describe the GPS satellite orbits, clock corrections, and other system parameters.

The GPS Navigation Message consists of time-tagged data bits marking the time of transmission of each subframe at the time they are transmitted by the SV. A data bit frame consists of 1500 bits divided into five 300-bit subframes. A data frame is transmitted every thirty seconds. Three six-second subframes contain orbital and clock data. SV Clock corrections are sent in subframe one and precise SV orbital data sets (ephemeris data parameters) for the transmitting SV are sent in subframes two and three. Subframes four and five are used to transmit different pages of system data. An entire set of twenty-five frames (125 subframes) makes up the complete Navigation Message that is sent over a 12.5 minute period. Data frames (1500 bits) are sent every thirty seconds. Each frame consists of five subframes. Data bit subframes (300 bits transmitted over six seconds) contain parity bits that allow for data checking and limited error correction.

GPS technology is becoming widely available to the general public. General aviation and corporate aircraft were the first to employ GPS navigation and positioning and in 2001, the Federal Communications Commission ordered cellular companies to equip all new cell phones with Global Positioning Satellite tracking devices that can pinpoint a user's location to within 300 feet, anywhere on the planet. The agency ordered the move at the behest of law enforcement agencies, who have long wished to be able to tell where 911 calls made on cell phones originate. Cell phone manufactures like Motorola, NEC, Nokia, Qualcomm, Treo, and Blackberry, just to name a few, incorporate a GPS chip with the circuitry of the cell phone for position information. The manufacture may provide the option of enabling or disarming of the GPS that is controlled by software allowing the user to select their choice, unless this is overwritten by dialing an emergency frequency, such as 911.

The cell phone service provider's facilities or MTSO 10 can be associated with a computer system 13 that upon a request from a cell phone or wireless PDA, whether by dedicated key, series of keys 42 or voice activation 44, calculates the geographic position or regional location of the cell phone. The geographic position or regional location of the cell phone can be determined either by the triangulation means 48 or GPS means 46 as described above. If GPS communication is allowed, the cell phone operator 20 may first have to elect enablement of the GPS communication by selecting the GPS option through software menus. Once the cell phone or wireless PDA's 30 general geographical position or regional location is calculated, then regional traffic information can be obtained by the cell phone service provider or downloaded through a cell phone provider/internet service provider. In these examples, the cell phone service provider obtains regional traffic information over the internet (by connecting to specific traffic websites) once the request is made by a cell phone operator or the regional traffic information can be maintained on a computer 13 and updated on a regular schedule by the cell phone service provider. The traffic information can be provided to the cell phone service provider by a third party.

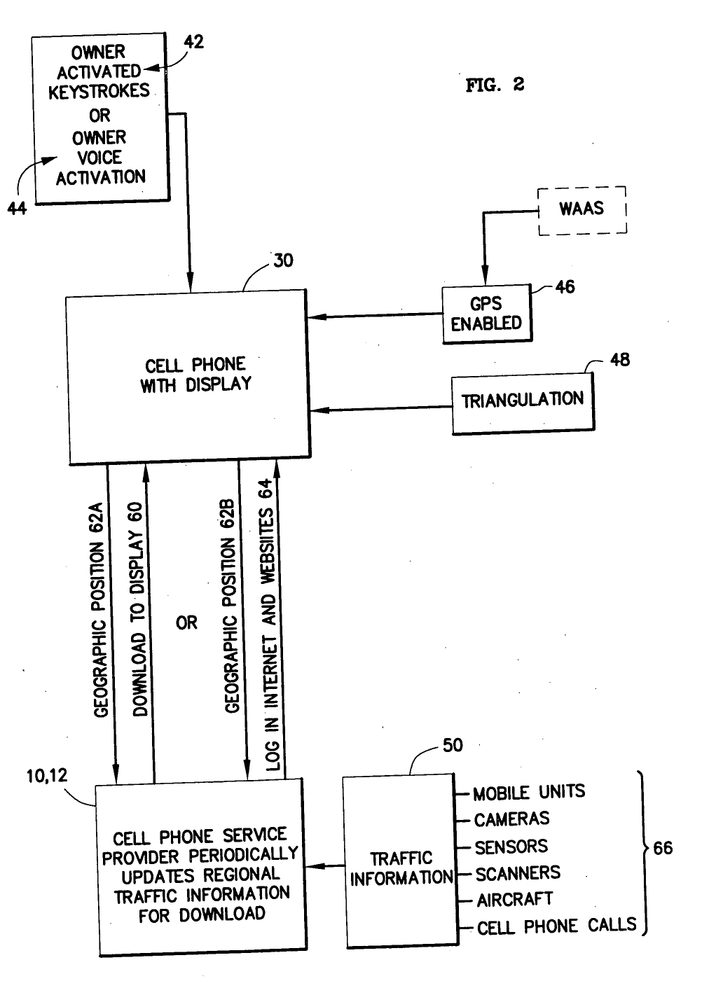

Now referring to FIG. 2, once the request for regional traffic information is made by owner activated keystrokes 42 or voice activation 44, and the geographic position of the cell calculated by GPS means 46 or triangulation means 48, the geographic position is provided to the cell phone service 62a or internet service provider 62b and the regional traffic information has been procured and is available by the cell phone service provider or internet service provider, the regional traffic information 50 an be downloaded by typical cell phone provider 60 or internet provider 64 using wireless means 22. Regional traffic information 50 generally will demonstrate major streets, highways and freeways with data showing traffic data, such as no traffic problem, slow moving traffic, heavy traffic. The different traffic categories can be display in different colors, e.g. green for no problem, yellow for slow moving traffic, and red for heavy traffic. Alternatively, the different traffic categories can be display with different symbols, e.g. smooth lines for no problem, hatched lines for slow moving traffic, and a series of small boxes for heavy traffic. The traffic information can be gathered for 24 hours and 7 days a week with updates from traffic sensors, mobile units, cameras, aircraft and cell phone calls. The information can calculate average speeds to provide travel times and to determine if traffic flow is clear, moderate, or heavy. There may be manned operations centers in various cities that employ traffic gathering operations to supplement data collected from our sensor network. These centers can collect ongoing traffic information from cameras, scanners, mobile units, aircraft and other sources.

The traffic data can also display incidents and events, such as car accidents. The various events are usually entered in real time during scheduled hours of operation by traffic professionals, who utilize an array of resources to track incidents including police, fire and agency sources, cameras, air-borne reporters, mobile units and call-ins from drivers. Some incidents involve special circumstances (injuries, spills, equipment availability, etc.), which can significantly hamper cleanup operations. The incidents can be displayed on the cell phone display with various symbols, e.g. triangle for a single incident, a diamond for an advisory, and a star for an event or alert.

It is an object of the present invention to minimize the number of keystrokes or use voice annunciation with possible software macro sequencing as necessary to provide regional traffic information because if the present invention is used while driving a vehicle, such distractions are highly undesirable, especially in heavy traffic conditions. Programmed voice activation of voice recording of an operator for a specific word or phrase which dials an associated phone numbers is technology currently available in cell phone software and features. It is anticipated that programmed voice activation to carryout a number of instructions (macro sequencing), such as 1) enablement of the GPS system, if needed, and 2) downloading regional traffic information provided directly or indirectly from a cell phone service provider or alternately 3) login to the interned and 4) enter a specific website and download regional traffic information on the display of the cell phone.

FIG. 2 depicts format a block diagram showing the owner activating a request for traffic information using a minimum of keystrokes 42 on the cell phone or employing a voice activation means 44, possibly coupled with a software macro sequence of instructions. The diagram shows that the cell phone 30 with display 31 can be located geographically by the use of GPS 46 (with ground based WAAS for further accuracy) or employ the method of triangulation 48 by monitoring of the cell phone with a plurality of cell towers. Once the geographic location is provided to the cell phone service provider 62b, regional traffic information can be obtained from logging into the internet and specific websites which have traffic data for downloading 64 the display 31 of the cell phone or wireless PDA 30. Alternately, the geographic position 62a can be provided to a cell phone provider 10 were regional traffic information has be procured from traffic data that is maintained, updated and stored on computer systems 13 by the cell phone service provider 10. As shown in the block diagram, the traffic information 50 is generated from various sources such as sensors, mobile units, cameras, scanners, aircraft and cell phone calls 66.

We claim:

1. A method for displaying traffic information on the display of a cell phone, comprising the steps:
accessing a traffic information acquisition means on a cell phone;
calculating the geographic location of a cell phone by a cell phone service provider computer generating a cell phone regional position;
said cell phone service provider obtaining traffic information for said cell phone regional position resulting in a regional traffic information;
said cell phone service provider transferring said regional traffic information to the cell phone; and
said cell phone displaying said traffic information on a video means.

2. The method as recited in claim 1, wherein said cell phone service provide computer calculates said regional position of the cell phone using triangulation technology.

3. The method as recited in claim 1, wherein said cell phone service provide computer calculates said regional position of the cell phone using global positioning system technology.

4. The method as recited in claim 1, wherein said cell phone service provider obtains said regional traffic information over the internet once the request is made by a cell phone operator.

5. The method as recited in claim 1, wherein said cell phone service provider obtains said regional traffic information maintained by the cell phone service provider that is obtained by a third party.

6. The method as recited in claim 1, wherein said traffic information acquisition means consists of a dedicated key on said cell phone.

7. The method as recited in claim 1, wherein said traffic information acquisition means consists of pressing one or more keys on said cell phone.

8. The method as recited in claim 1, wherein said traffic information acquisition means consists of a macro sequence that is implemented by one or more keystrokes.

9. The method as recited in claim 8 comprises a macro sequence that first logins into an internet provider, then accesses a specific website which has regional traffic information, and then downloads regional traffic information on the display of the cell phone.

10. The method as recited in claim 9, further comprising the step of enabling the cell phone to communicate a GPS system prior to logging into the internet.

11. The method as recited in claim 10, further comprising the step that said macro sequence disenables or disengages cell phone communication with the GPS system when said downloading of said regional traffic information to the display of said cell phone is completed.

12. The method as recited in claim 1, wherein said traffic information acquisition means consists of a voice activation means.

13. The method as recited in claim 12, wherein said voice activation means implements a macro sequence.

14. The method as recited in claim 13 comprises a macro sequence that first logins into an internet provider, then accesses a specific website which has regional traffic information, and then downloads regional traffic information on the display of the cell phone.

15. The method as recited in claim 14, further comprising the step of enabling the cell phone to communicate a GPS system prior to logging into the internet.

16. The method as recited in claim 15, further comprising the step that said macro sequence disenables or disengages cell phone communication with the GPS system when said downloading of said regional traffic information to the display of said cell phone is completed.
